(19) United States
(12) Patent Application Publication
(10) Pub. No.: US 2026/0365097 A1
(43) Pub. Date: Nov. 19, 2026

(54) Lifting and Transporting Apparatus and Method

(71) Applicant: Thomas F. Egan, Binghamton, NY (US)

(72) Inventor: Thomas F. Egan, Binghamton, NY (US)

(21) Appl. No.: 19/729,317

(22) Filed: Jul. 23, 2026

Related U.S. Application Data
(63) Continuation of application No. 17/803,767, filed on Nov. 17, 2022, now Pat. No. 12,703,290.
(60) Provisional application No. 63/361,015, filed on Nov. 17, 2021.

(51) Int. Cl. B60P 1/54; B60P 1/44; B60S 9/02; B66C 23/78; B66F 9/075; E02F 9/08

(52) U.S. Cl. CPC B60P 1/548; B60P 1/4485; B66F 9/07559; B60S 9/02; B66C 23/78; E02F 9/085

(57) ABSTRACT

A lifting and transporting apparatus and method are disclosed. In one particular embodiment, the apparatus and method may be realized as an apparatus for lifting and transporting objects comprising a vertical support beam, the vertical support beam comprising at least one first attachment means for removably rotatably attaching an object for accepting lifted objects, the vertical support beam comprising at least one second attachment means for removably rotatably attaching a lifting apparatus for lifting objects; and a plurality outriggers pivotably attached to a lower end of the vertical support beam, each outrigger comprising an arm extending away from the vertical support beam in a substantially horizontal position in a deployed state and pivoting to a substantially vertical position in a stowed state, each outrigger arm having a mounting means substantially at an end thereof for supporting the vertical support beam in a substantially vertical orientation while in the deployed state.

### CROSS-REFERENCE TO RELATED APPLICATIONS

This patent application claims priority to U.S. Provisional Patent Application No. 63/361,015, filed Nov. 17, 2021, which is hereby incorporated by reference herein in its entirety.

### FIELD OF THE DISCLOSURE

The present disclosure relates generally to systems for lifting and transporting objects and, more particularly, to a lifting and transporting apparatus and method.

### BACKGROUND OF THE DISCLOSURE

When lifting and transporting objects, it can often be difficult to initially lift the objects due to their weight. It can also be difficult to move the objects once lifted, also due to their weight and the distance the objects need to travel. These difficulties can often be exacerbated by the terrain upon or over which the objects must be lifted and transported. And when many objects require lifting and transporting, human efforts to accomplish the lifting and transporting tasks may be limited.

In view of the foregoing, it may be understood that there may be significant problems and shortcomings associated with current systems for lifting and transporting objects.

### SUMMARY OF THE DISCLOSURE

A lifting and transporting apparatus and method are disclosed. In one particular embodiment, the apparatus and method may be realized as an apparatus for lifting and transporting objects comprising a vertical support beam, the vertical support beam comprising at least one first attachment means for removably rotatably attaching an object for accepting lifted objects, the vertical support beam comprising at least one second attachment means for removably rotatably attaching a lifting apparatus for lifting objects; and a plurality outriggers pivotably attached to a lower end of the vertical support beam, each outrigger comprising an arm extending away from the vertical support beam in a substantially horizontal position in a deployed state and pivoting to a substantially vertical position in a stowed state, each outrigger arm having a mounting means substantially at an end thereof for supporting the vertical support beam in a substantially vertical orientation while in the deployed state.

In accordance with other aspects of this particular embodiment, the mounting means comprises a caster assembly.

In accordance with other aspects of this particular embodiment, the mounting means comprises a pad assembly.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a . . . in accordance with an embodiment of the present disclosure.

FIG. 1 shows an oblique rear view of a lifting and load transferring apparatus in accordance with an embodiment of the present disclosure with a fork adapter picking device option deployed, with a powered parallel-arm lift arm assembly option shown in a horizontal position, and an entire assembly pointing substantially rearward of an object to which the system is mounted.

FIG. 2 shows an oblique right rear view of a lifting and load transferring apparatus in accordance with an embodiment of the present disclosure with a platform adapter picking device option deployed, with a powered parallel-arm lift arm assembly option shown in a horizontal position, and a lift pointing substantially rearward of an object to which the system is mounted.

FIG. 3 shows an oblique right rear view of a lifting and load transferring apparatus in accordance with an embodiment of the present disclosure inducing a seat option deployed, with a powered parallel-arm lift arm assembly option shown in a horizontal position, with an entire assembly pointing substantially rearward of an object to which the system is mounted.

FIG. 4 shows an oblique right rear view of a typical object to which an assembly embodiment of the present disclosure may be mounted in accordance with an embodiment of the present disclosure, highlighting typical mounting points for the assembly's support structure.

FIG. 5 shows an oblique assembly view of a vertical support beam in accordance with an embodiment of the present disclosure, and outrigger pivot joints.

FIG. 5a shows an oblique assembly view of a vertical support beam in accordance with an embodiment of the present disclosure, and outrigger pivot joints in a version compatible with powered outrigger actuation.

FIG. 6 shows a view of a main vertical support beam, a hinged joint of an outrigger assembly, and outriggers with the outriggers in a horizontal/deployed position in accordance with an embodiment of the present disclosure.

FIG. 6a shows an oblique view of an outrigger with caster assembly in accordance with an embodiment of the present disclosure, with the outrigger in a horizontal/deployed position and fully retracted.

FIG. 6b shows an oblique detail view of an end of an outrigger caster assembly in accordance with an embodiment of the present disclosure, with the outrigger in a horizontal/deployed position and fully retracted.

FIG. 6c shows an oblique detail view of an end of an outrigger caster assembly in accordance with an embodiment of the present disclosure, with the outrigger in a horizontal/deployed position and fully retracted, with an adjustable mount of a caster arm adjusted to accommodate a maximum elevation of an outrigger arm to which it is attached.

FIG. 6d shows an oblique detail view of an end of an outrigger caster assembly in accordance with an embodiment of the present disclosure, with the outrigger in a horizontal/deployed position and fully retracted, with an adjustable mount of a caster arm adjusted to accommodate a minimum elevation of an outrigger arm to which it is attached.

FIG. 6e shows an oblique view of outriggers with pad assemblies in accordance with an embodiment of the present disclosure, with the outriggers in a horizontal/deployed position and fully retracted.

FIG. 6f shows an oblique view of outriggers with casters in accordance with an embodiment of the present disclosure, depicting a hydraulic actuation option, with outriggers in a horizontal/deployed position and fully retracted.

FIG. 6g shows an oblique view of outriggers with pad assemblies in accordance with an embodiment of the present disclosure, depicting a hydraulic actuation option, with outriggers in a horizontal/deployed position and fully retracted.

FIG. 6h shows an oblique detail view of an outrigger leg with caster assembly in accordance with an embodiment of the present disclosure, in a horizontal/deployed position and fully retracted.

FIG. 6i shows an oblique detail view of an outrigger leg with pad assembly in accordance with an embodiment of the present disclosure, in a horizontal/deployed position and fully retracted.

FIG. 6j shows an oblique detail view of an outrigger leg with pad assembly in accordance with an embodiment of the present disclosure, depicting a hydraulic actuation option, in a horizontal/deployed position and fully retracted.

FIG. 7 shows a view of a main vertical support beam, a hinged joint of an outrigger assembly, and outriggers with caster assembly, with the outriggers in a vertical/stowed position in accordance with an embodiment of the present disclosure.

FIG. 7a shows a view of a main vertical support beam, a hinged joint of an outrigger assembly, and outriggers with pad assemblies, with the outriggers in a vertical/stowed position in accordance with an embodiment of the present disclosure.

FIG. 7b shows a view of a main vertical support beam, a hinged joint of an outrigger assembly, and outriggers with caster assemblies, depicting a hydraulic actuation option, with the outriggers in a vertical/stowed position in accordance with an embodiment of the present disclosure.

FIG. 7c shows a view of a main vertical support beam, a hinged joint of an outrigger assembly, and outriggers with pad assemblies, depicting a hydraulic actuation option, with the outriggers in a vertical/stowed position in accordance with an embodiment of the present disclosure.

FIG. 8 shows an oblique view of extensions that connect a lift arm assembly and a support structure assembly in accordance with an embodiment of the present disclosure.

FIG. 9 shows an oblique rear view of a typical object to which an embodiment of the present disclosure is mounted, with a vertical support beam, deployed outriggers, and multiple articulated extensions attached to the vertical support beam in accordance with an embodiment of the present disclosure.

FIG. 10 shows an oblique view of a lift arm assembly with a fork adapter picking device option in accordance with an embodiment of the present disclosure.

FIG. 11 shows an oblique view of a lift arm assembly with a platform adapter picking device option in accordance with an embodiment of the present disclosure.

FIG. 12 shows an oblique view of a lift arm assembly with a seat adapter picking device option in accordance with an embodiment of the present disclosure.

FIG. 13 is an oblique right rear view of a lifting and load transferring apparatus in accordance with an embodiment of the present disclosure with a platform/fork adapter option deployed, with a powered parallel-arm lift arm assembly in a horizontal position, with a view showing a side of a multi-axis pivot joint at a head of the powered parallel-arm lift assembly.

FIGS. 13a and 13b are oblique views of a lifting and load transferring apparatus in accordance with an embodiment of the present disclosure with a platform/fork adapter option deployed, with a powered parallel-arm lift arm assembly in a horizontal position, with a detail view demonstrating various rotational capabilities of a multi-axis pivot joint at a head of the powered parallel-arm lift assembly.

FIG. 14 is an oblique view of a lifting and load transferring apparatus in accordance with an embodiment of the present disclosure, showing a view of extensions and a lift arm assembly in a stowed position, with an upper parallel arm of a powered parallel-arm lift assembly engaged with a docking capture arm attached to a main vertical support, securing the upper parallel arm and the entire apparatus when the lift is not in use.

FIG. 14a is a detail view of FIG. 14 showing how hinges of the extensions interlock in the stowed position in accordance with an embodiment of the present disclosure.

### DETAILED DESCRIPTION OF EMBODIMENTS

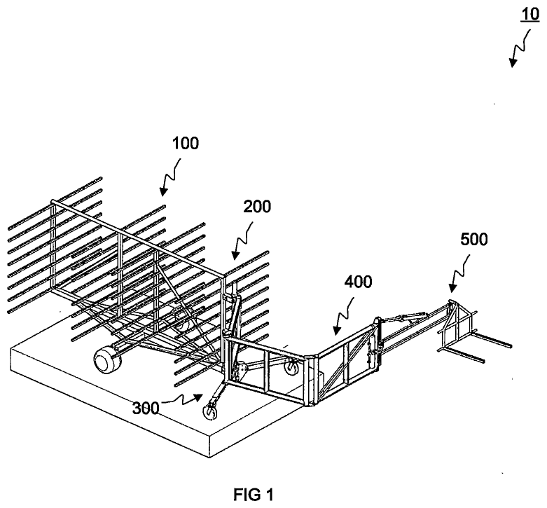

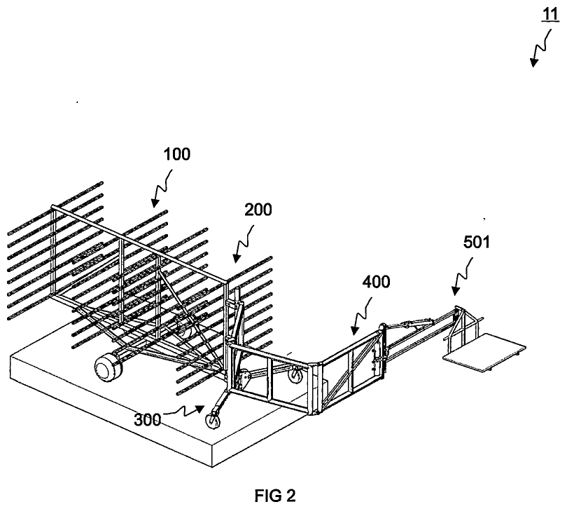

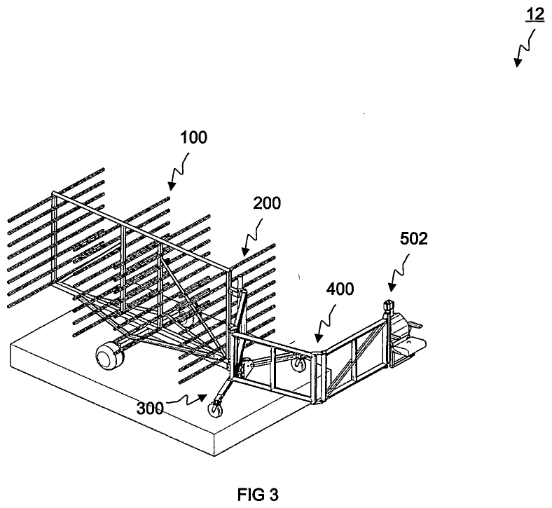

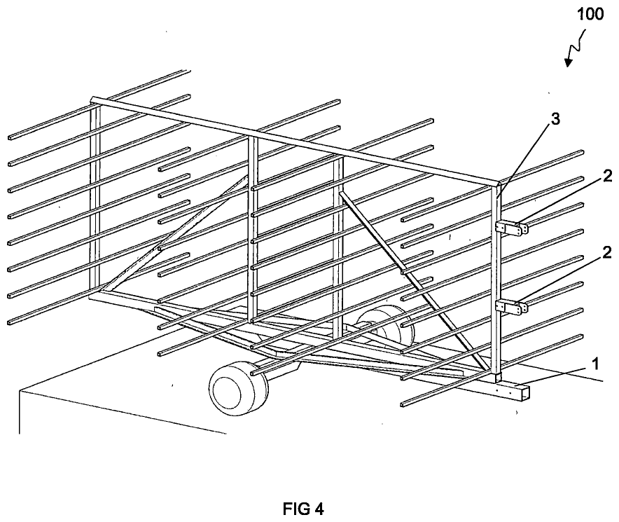

Referring to FIGS. 1-3, there are shown lifting and load-transferring apparatuses 10, 11, and 12 in accordance with embodiments of the present disclosure. FIG. 1 represents an embodiment of the present disclosure with a mounting object 100 to which the apparatus 10 is mounted, consisting of a main vertical support beam assembly 200 incorporating an outrigger assembly 300 with casters, and connected in sequence to extensions 400 and powered parallel-1 arm lift arm assembly fork adapter option 500. FIG. 2 represents an embodiment of the present disclosure with a mounting object 100 to which the apparatus 11 is mounted, consisting of a main vertical support beam assembly 200 incorporating outriggers 300 with casters, and connected in sequence to extensions 400 and powered parallel-arm lift arm assembly with platform adapter option 501. FIG. 3 represents an embodiment of the present disclosure with a mounting object 100 to which the apparatus 12 is mounted, consisting of a main vertical support beam assembly 200 incorporating outriggers 300 with casters, and connected in sequence to extensions 400 and powered parallel-arm lift arm assembly with seat adapter option 502.

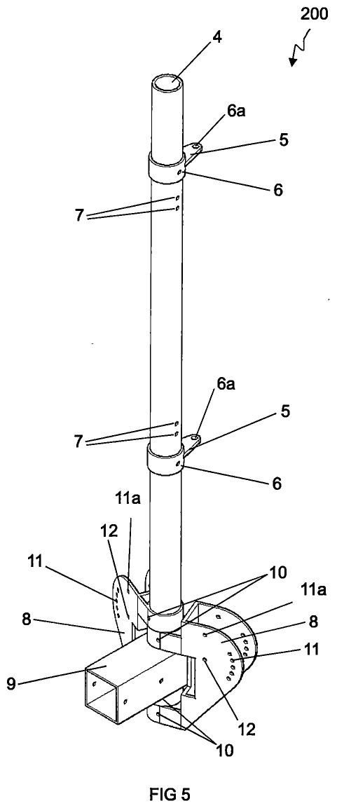

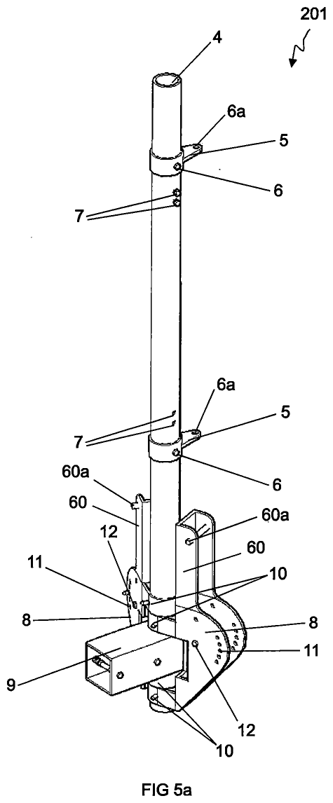

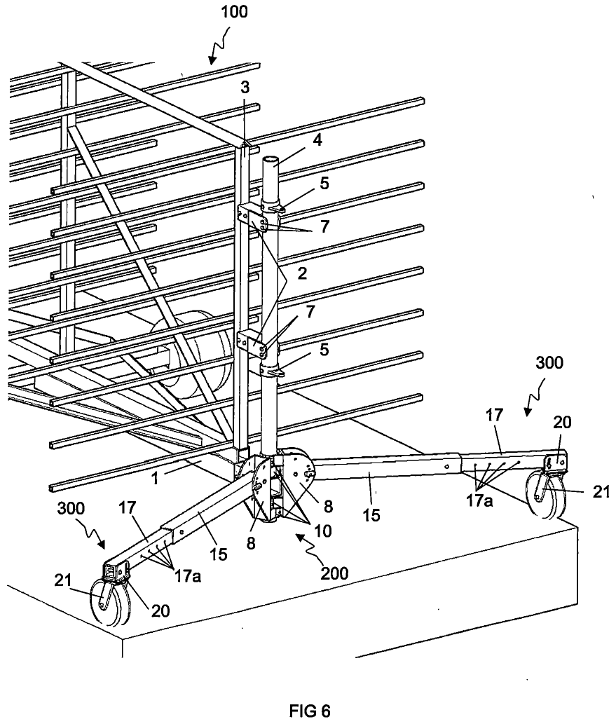

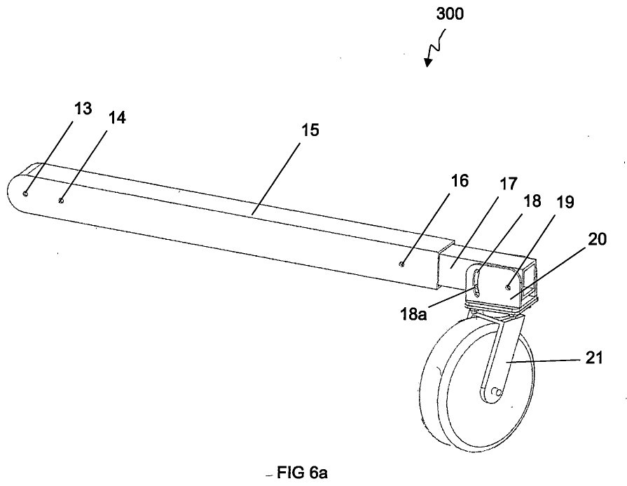

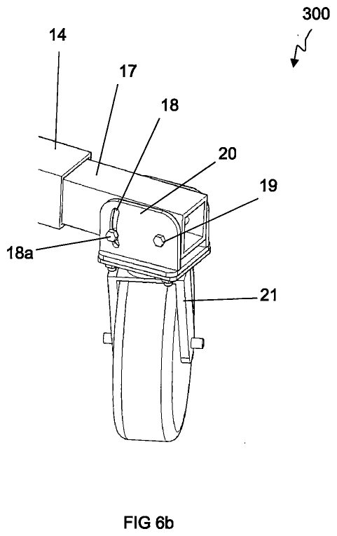

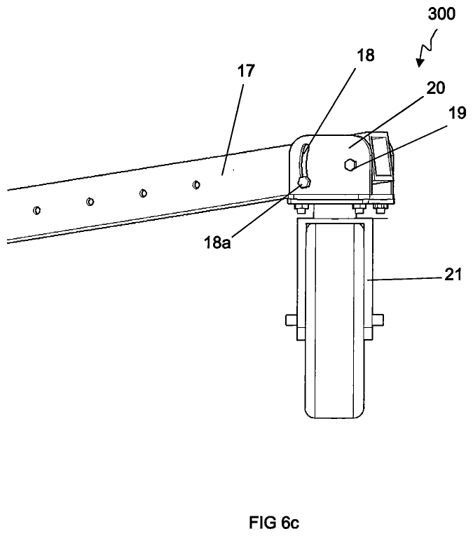

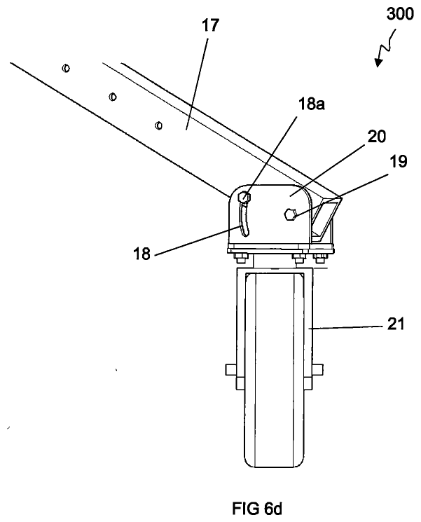

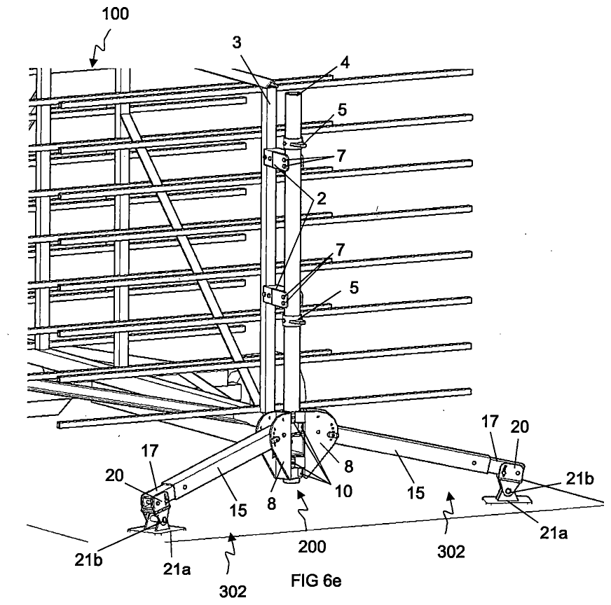

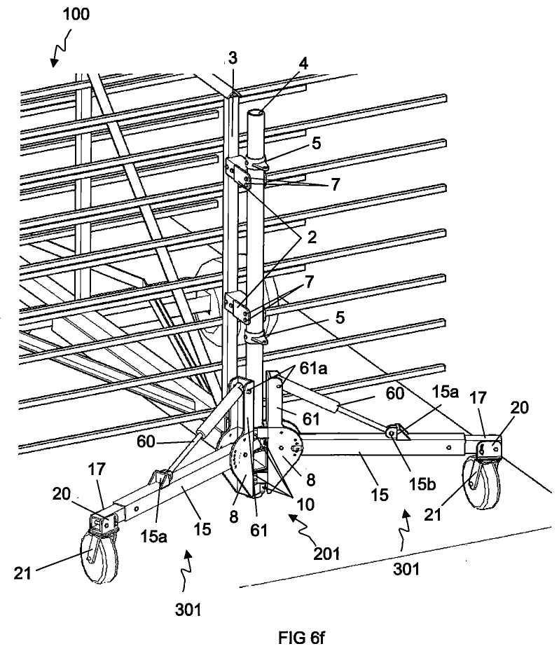

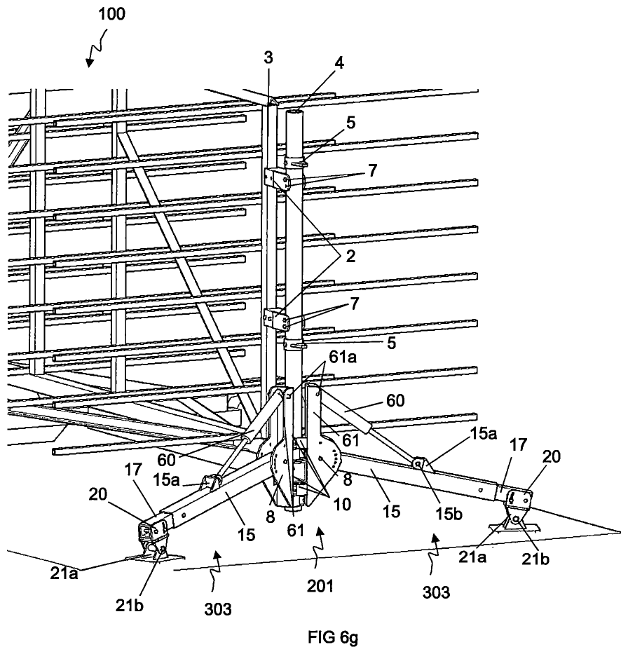

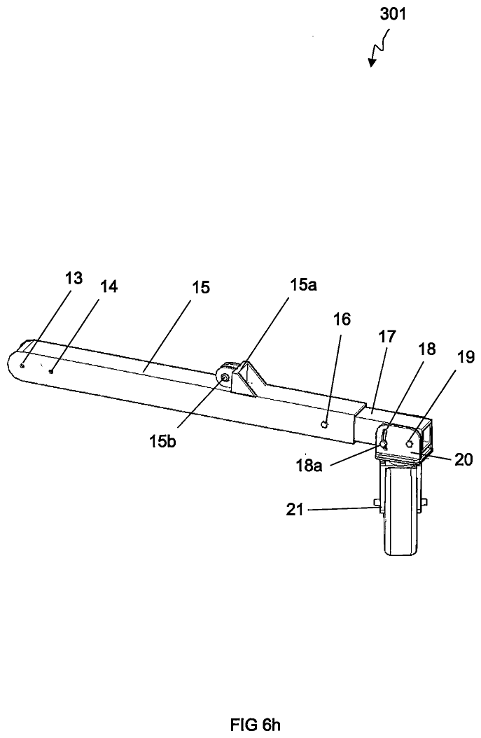

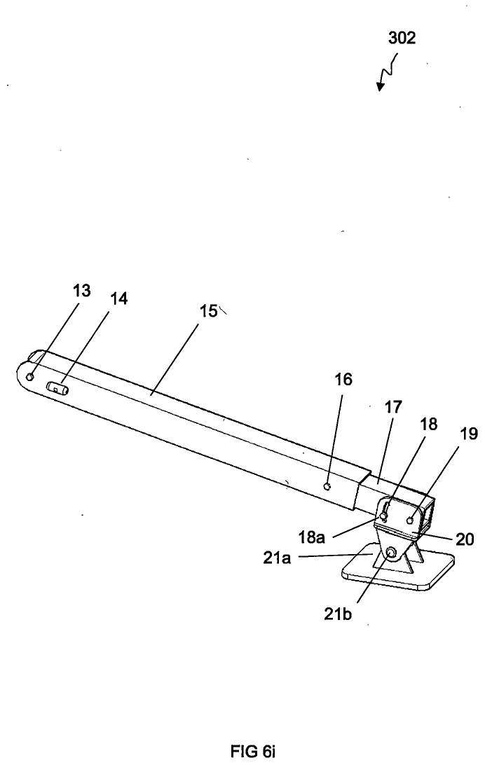

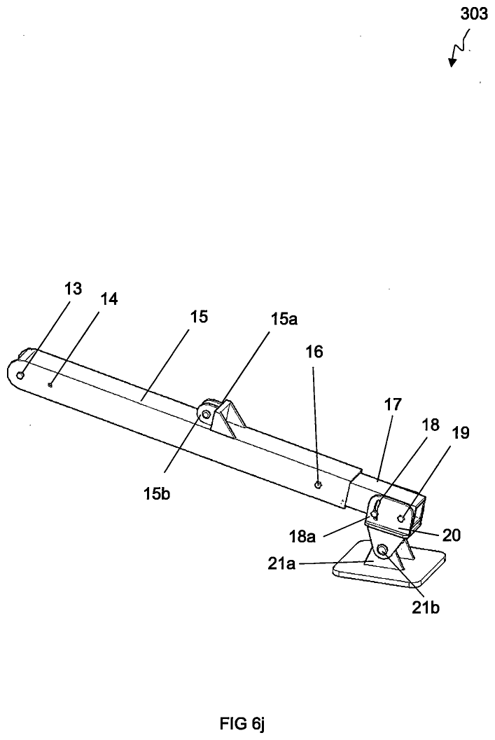

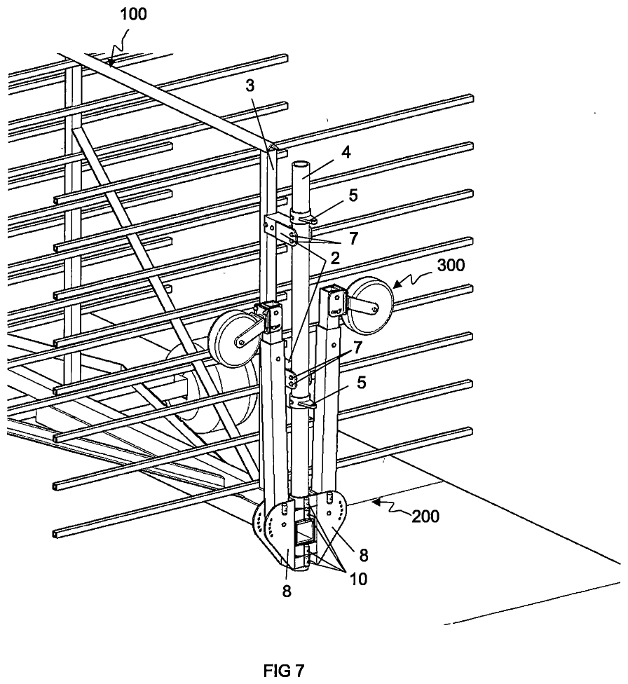

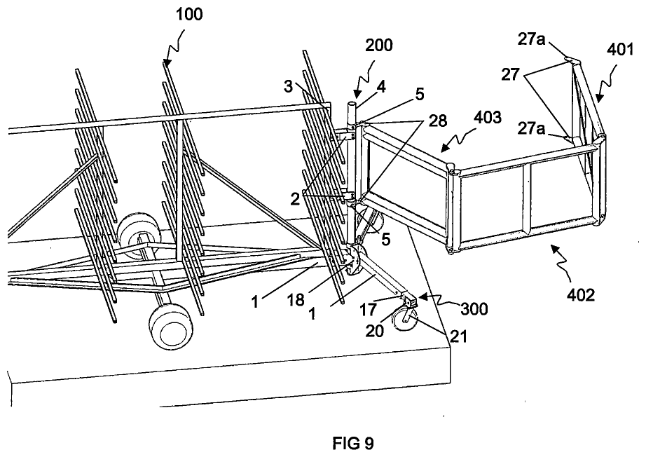

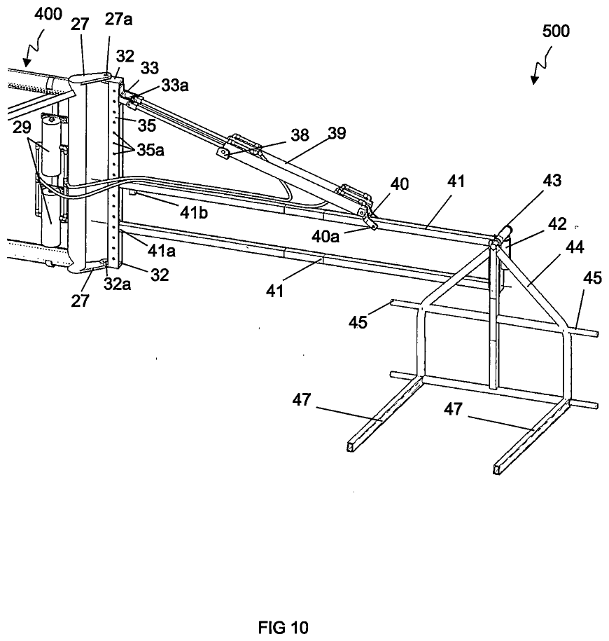

Beginning from the left of apparatuses 10, 11, and 12, as shown in FIGS. 1-3, and moving rightward, assembly 200 is secured to mounting object 100 by means of mounting points and supports 1, 2, 3, as shown in FIGS. 4, 6, 6e, 6f, 6g. Mounting points 1, 2, 3 are securely fastened to vertical support beam 4 through connection holes 7 and insertion into mounting object interface tube 9, as shown in FIGS. 5 and 5a. At this point it should be noted that a wide variety of connection methods and materials could allow vertical support beam 4 to be connected to mounting object 100, including but not limited to screws, clamps, glues, or other popular methods of binding. Vertical support beam 4 could also be integrated into mounting object 100, or utilize an appropriate structure within mounting object 100. Vertical support beam hinge tabs 5 are secured through holes 6 into vertical support beam 4, and incorporate vertical support beam hinge tab pivot holes 6a for the purpose of allowing system first extension 401 (FIGS. 8 and 9) to rotate freely about a substantially vertical axis. It should be noted that the tubular design of vertical support beam 4 presents an advantage from a manufacturing perspective of allowing a single part to provide a central axle for outrigger pivot assemblies 8 (FIGS. 5 and 5a) while giving vertical support beam hinge tabs 5 positional adjustability depending on where vertical support beam hinge tab hole 6 is drilled. Mounting object interface tube 9 provides a clear advantage from a functional and installation perspective, as it may allow for easy mounting and removal of the product as it may be able to be inserted inside of or slid over the outside of existing structure of mounting object 100. In the case where a load to be transferred is of an appropriate weight, mounting object interface tube 9 may also obviate the need for additional mounting hardware such as lower support beam mount 1, and mid support beam mount 2. The unique design of the combination of outrigger pivot assemblies 8, the lower section of vertical support beam 4, and outrigger outer arms 15 (FIGS. 6-6j) allows for a combination of a wide variety of rotational angles between outrigger pivot assemblies 8 and mounting object 100, in order to accommodate required support vectors when system 10, 11, or 12 is picking loads at various angles.

In the outrigger assembly 300 with casters variant of apparatuses 10, 11, and 12, and as shown in FIGS. 5 and 5a, the system is constructed substantially as described above, with the addition that the combination of outrigger outer arm assembly hole 12 and outrigger outer arm angle adjustment holes 11, plus outrigger outer arm stowage holes 11a, allow a standard locking pin to be placed either in the array of holes of outrigger outer arm angle adjustment holes 11 for a variety of angles to accommodate various terrains, or stowage when placed in outrigger outer arm stowage holes 11a in alignment with outrigger outer arm positioning hole 14. Continuing downward and outward, and with reference to FIGS. 6-6j, outrigger assembly 300 with casters incorporates outrigger outer arm 15, outrigger inner arm 17, caster mount 20, and caster 21. The total length of these element can easily be regulated with use of a standard locking pin inserted in outrigger outer arm length adjustment hole 16 to enter into a plurality of holes 17a to accommodate various required lengths when lifting variously cantilevered loads on uneven terrain. Since various angular adjustments of outrigger outer arm 15 change the plane of rotation of caster assembly 21, it is preferrable to have a design that allows correction of a vertical rotational axis of caster assembly 21. The design of caster mount 20 accomplishes this by incorporating a radial slot, caster mount swivel slot 18, which when interacting with caster mount swivel hole 19, creates a secure mount for caster assembly 21 and a substantially vertical axis of rotation of caster 21 when bolts are placed through caster mount swivel holes 19 and outrigger inner arm caster mount swivel slot hole 18a.

In the outrigger assembly 301 with casters and powered actuation variant of apparatuses 10, 11, and 12, as shown in FIGS. 5a, 6h and 6f, the system is constructed substantially as described above in reference to assemblies 300 and 200, however in lieu of the manual rotation outrigger outer arms 15 and outrigger inner arms 17, the combination of the extension and retraction of outrigger arm actuator 60, connected to pivot points outrigger pivot assemblies actuator extender holes 61a at the end of outrigger pivot assemblies actuator extender 61, outrigger outer arm actuator bracket holes 15b, and the connection between outrigger outer arm assembly holes 12 and outrigger outer arm pivot holes 13 work jointly to create rotational movement of outrigger outer arm 15 about a substantially horizontal axis. This is useful in high productivity environments where there is uneven terrain and varying loads on mounting object 100 as the time required to reposition an angle of outrigger outer arm 15, and/or a position of caster mount 20 to compensate for differences would be detrimental. The length of the combination of outrigger outer arm 15 and outrigger inner arm 17, as well as the position of caster mount 20, can be regulated as described above in the description of assembly 300.

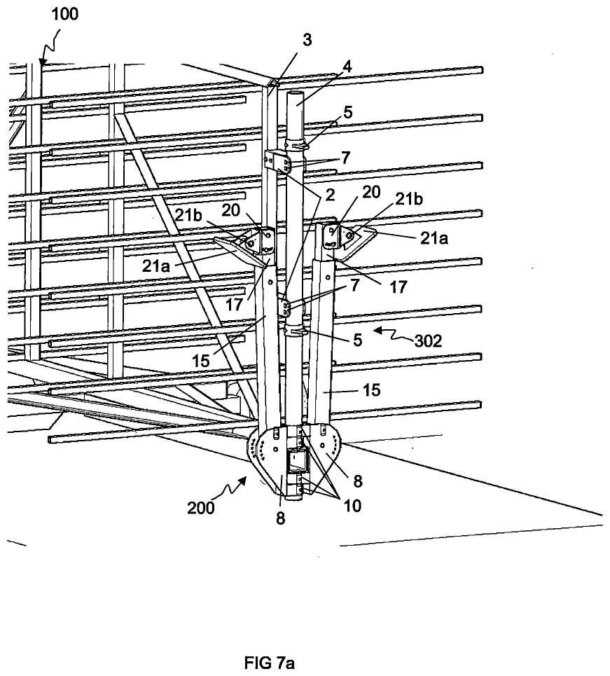

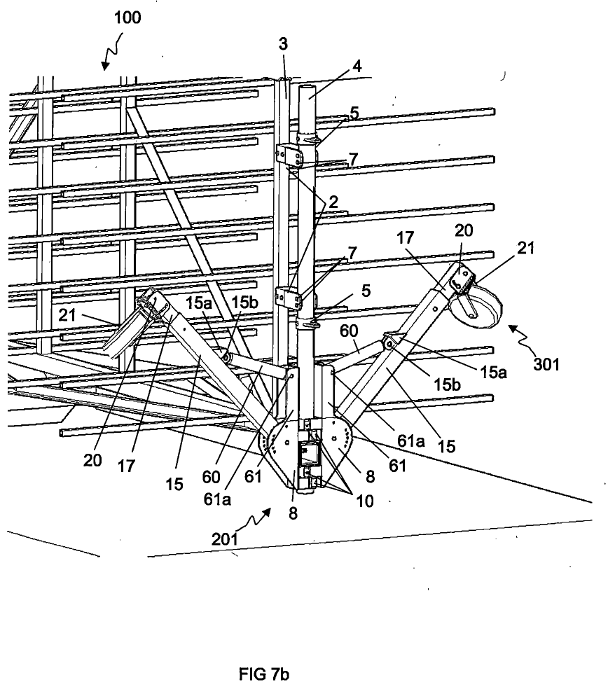

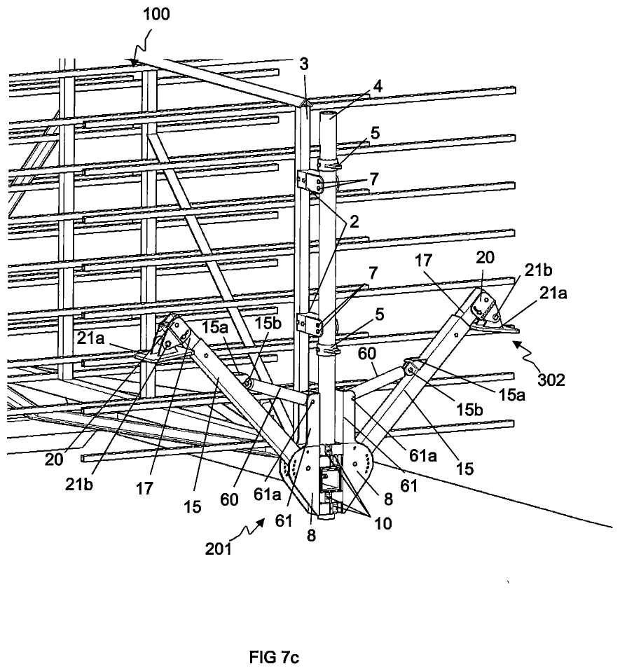

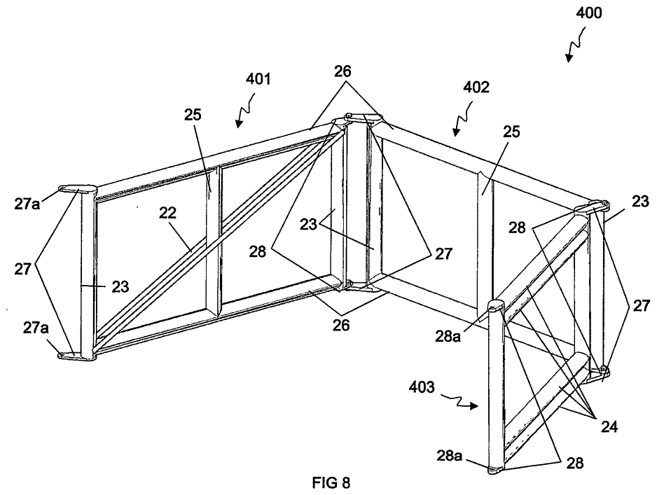

In the outrigger assembly 302 with pads variant of apparatuses 10, 11, and 12, all aspects of the system function as described above in reference to assemblies 200 and 300, with the exception that caster assembly 21 is replaced by pad assembly 21a, as shown in FIGS. 7a, 6e, 6g, 6i, 6j. Pad assembly 21a incorporates pivoting pad assembly joint 21b to allow multi-axis pivoting of the joint to match up to uneven terrain. An additional advantage of this style of connection with the ground below assembly 302 is that it spreads the load over a much wider surface area than the caster assemblies 21 whose contact surfaces are limited to small areas at the bottom of their wheels. This is clearly an advantage in soft terrains where penetration into soil can cause deflection in the entire system especially under heavy loads.

In the outrigger assembly 303 with pads and powered actuation variant of apparatuses 10, 11, and 12, all aspects of the system function as described above in reference to assemblies 200 and 301, with the exception that caster assembly 21 is replaced by pad assembly 21a as shown in FIGS. 6g and 7c, features of which are discussed with reference to assembly 302 and referenced in FIG. 6j.

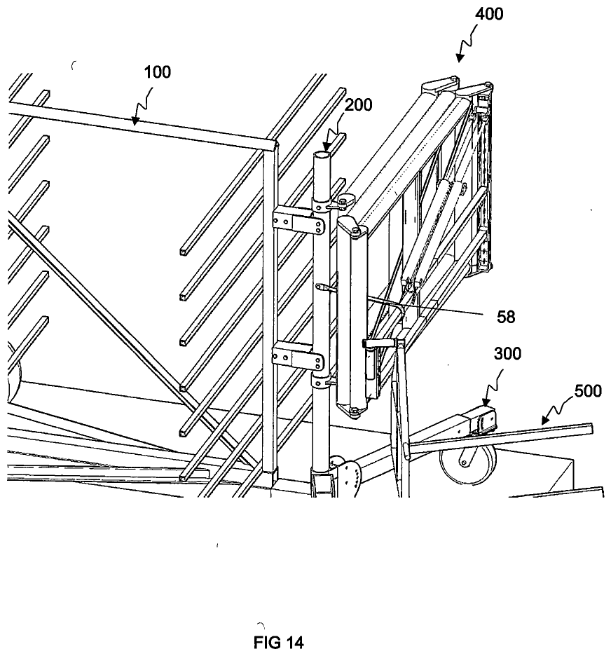

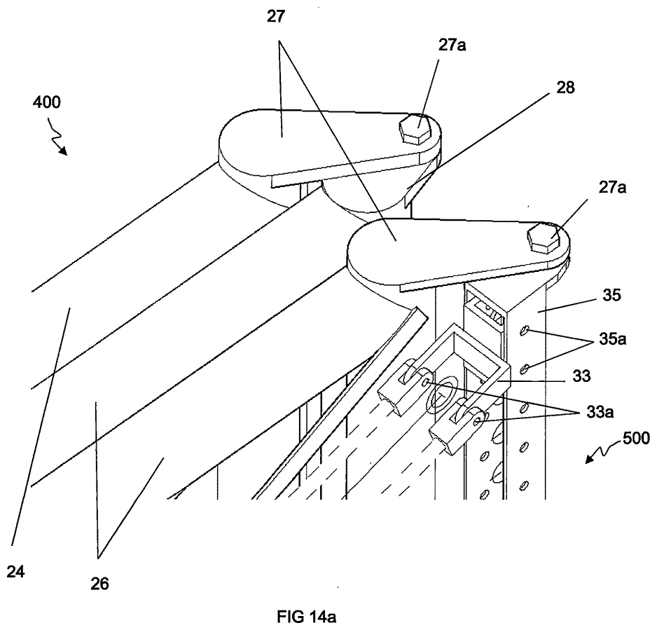

Continuing rightward, FIGS. 8, 9, 14 and 14a refer to extensions assembly 400, as well as first extension 401, second extension 402, and third extension 403. FIG. 8 shows an array of three extensions, first extension 401, second extension 402, and third extension 403. Beginning at the left side of first extension 401, extension hinge joint tab long 27 is fixedly attached to extension side vertical support 23, which is in turn fixedly attached to extension upper and lower horizontal support 26 at both the top and bottom of extension side vertical support 23. Extension center vertical support 25 is fixedly attached in between the upper and lower extension upper and lower horizontal support 26. At the right of system 401 is fixedly attached an additional extension side vertical support 23, with two extension hinge joint tab short 28 fixedly attached at the top and bottom. It should be noted that extension hinge joint tab long 27 is attached to extension side vertical support 23 at such an angle as to permit flat folding when system 400 is folded for stowage as shown in FIG. 14. Thus, upper and lower extension hinge joint tab holes 27a are located so as to align with upper and lower vertical support beam hinge tab pivot holes 6a of assembly 200, in such a manner as to provide free rotation about a substantially vertical axis. In similar fashion, at the joint between first extension 401 and second extension 402, extension hinge joint tab long hold 27a upper and lower of second extension 402 are positioned so as to interface with extension hinge joint tab short hole 28a in such a manner as to provide free rotation about a substantially vertical axis running through both holes. Connections and interaction between third extension 403 and second extension 402 are as described immediately above as between first extension 401 and second extension 402. In the interest of maximizing strength to weight ratio, and to avoid potential for sagging when under load, extension sag support straps 22 may be added to extensions 401, 402, or 403. It should also be noted that additional extensions as depicted in first extension 401, second extension 402, and third extension 403 can be added as needed as per requirements of a particular lifting and loading environment. From a user and functional perspective, the assembly 400 offers a particularly advantageous design combination of torsional rigidity, wide-ranging three-dimensional movement and placement of a load to be transferred, and the ability to be stowed relatively flat so as to minimize space occupied when not in use. The unique design of the extension 401, 402, and 403 typically incorporate round tubes for vertical and horizontal supports 25, 23, 26, 24, which have superior torsional rigidity and strength-to-weight ratio characteristics as compared to other shapes of tubing or solid media. Although the disclosed design refers to round tubing as the construction material of choice for these elements, the present disclosure should not be limited in scope by this particular embodiment of these support members, thus square, rectangular, triangular, and/or other solid shapes should be considered within the scope of the present disclosure.

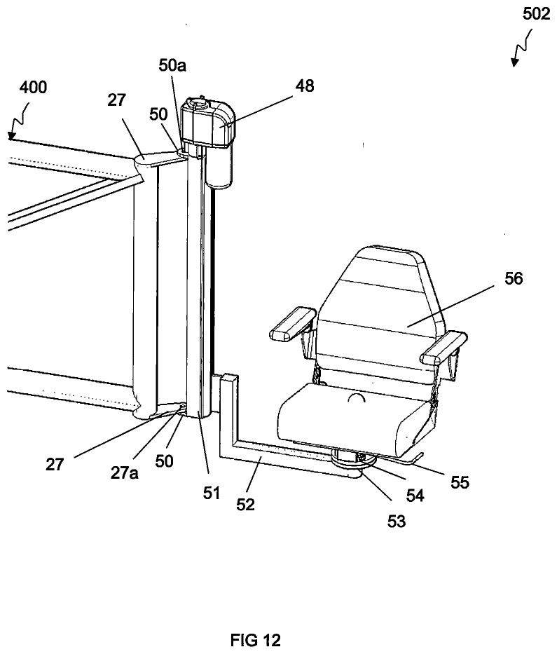

Continuing rightward, FIGS. 2, 11, 13, 13a, and 13b disclose apparatus 11 and parallel-arm lift arm assembly 501 with platform adapter picking device. Beginning at the left and moving rightward, extension assembly 401 extension hinge joint tab long hole 27a upper and lower are designed to align with parallel-arm lift arm assembly vertical support beam pivot tab hole 32a upper and lower so that the two pairs may be bolted together in such a manner as to allow rotation between assembly 401 or any other subsystem of system 400 or even system 200 and system 501 about a substantially vertical axis. Upper and lower parallel-arm lift arm assembly vertical support beam pivot tabs 32 are fixedly attached at the top and bottom of parallel-arm lift arm assembly vertical beam 35. Parallel-arm lift arm assembly vertical beam adjustment holes 35a are an array of holes that can be used alternately as connection points for parallel arms 41 and actuator mount parallel-arm lift arm assembly vertical beam side 33. Parallel arm lift assembly actuator 39 incorporates a hole that is pivotally attached to actuator mount parallel arm lift arm assembly vertical beam side 33 by means of a bolt or other axle inserted into actuator mount parallel-arm lift arm assembly vertical beam side hole 33a, thus allowing rotation about a substantially horizontal axis. Similarly, a combination of a provided hole in the lower section of parallel arm lift assembly actuator 39, actuator mount parallel-arm lift arm assembly parallel arm side 40, and actuator mount parallel-arm lift arm assembly parallel arm side hole 40a allow rotation about a substantially horizontal axis between actuator 39 and parallel arm 41. In further similar fashion, parallel-arm lift arm assembly parallel arm hole 41a is provided at each end, allowing holes on the left and to be engaged with holes 35a in various locations, allowing again for rotation about a substantially horizontal axis. The multiple holes of hole array 35a can be utilized in conjunction with various location settings in actuator mount parallel-arm lift arm assembly vertical beam side 33 and parallel arms 41 to create a wide variety of lifting geometries yielding multiple combinations of force, mechanical advantage, and vertical travel. As the mechanism raises the load, the geometry of the system causes upper parallel arm 41 to become proximate to lower parallel arm 41. As a safety measure to prevent overtravel, parallel arm limit switch 41b may be engaged to stop upward motion at a point determined by its positioning and size. It is important to point out that parallel arm lift assembly actuator 39 may consist of a number of popular drive mechanisms including, but not limited to, hydraulic, screw drive, pneumatic, rack and pinion, and other popular drive methods.

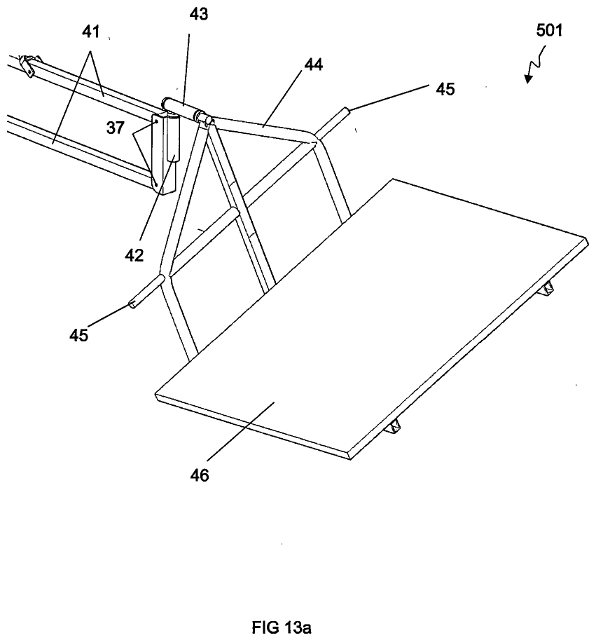

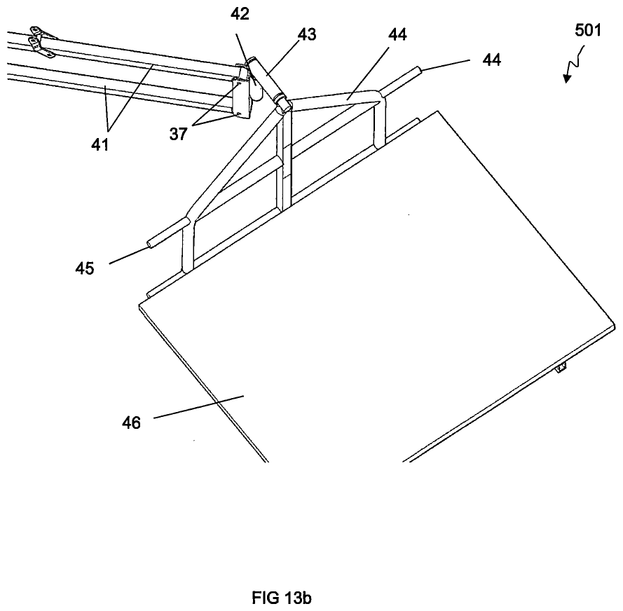

Continuing further rightward, parallel-arm lift arm assembly receiver pivoting head vertical axis 42 has a dual function of providing axle/pivot point holes to engage with parallel-arm lift arm assembly vertical beam adjustment holes 37 (see FIGS. 13-13b) of the upper and lower parallel arms 41, as well as providing a vertical pivotal joint designed to engage with a pin protruding downward from parallel-arm lift arm assembly receiver pivoting head horizontal axis 43 into parallel-arm lift arm assembly receiver pivoting head vertical axis 42, in such a manner as to provide free rotation of parallel-arm lift arm assembly receiver pivoting head horizontal axis 43 about a substantially vertical axis. Picking device support structure 44 incorporates a pin that is inserted into parallel-arm lift arm assembly receiver pivoting head horizontal axis 43 permitting free rotation about a substantially horizontal axis. Picking device support structure handles 45 allow for easy hold points when maneuvering loads with the system. Platform adapter picking device platform 46 is fixedly attached to the base of Picking device support structure 44 to facilitate lifting and loading of objects that require a flat surface. It should be noted that a critical advantage of the design of parallel-arm lift arm assembly 500 with fork adapter picking device and parallel-arm lift arm assembly 501 with platform adapter picking device is the interplay between parallel-arm lift arm assembly receiver pivoting head vertical axis 42, parallel-arm lift arm assembly receiver pivoting head horizontal axis 43, and the height of picking device support structure 44. Since the center of gravity tends to be substantially lower than parallel-arm lift arm assembly receiver pivoting head horizontal axis 43, platform adapter picking device platform 46 will tend to find its center of gravity in a horizontal position thus stabilizing any load being borne, while parallel-arm lift arm assembly receiver pivoting head vertical axis 42 allows for free rotation through a wide arc. This feature, in conjunction with the great positional flexibility of assembly 400 depicted in particular in FIG. 9. allows for an unparalleled three-dimensional movement flexibility. It should be noted that this apparatus 11 can be configured to incorporate assemblies 200, 201, 300, 301, 302, 303 and multiple configurations of assembly 400 and extensions 401, 402, and 403 and is subject to the general descriptions and discussions of assemblies 200, 300, and 400 above.

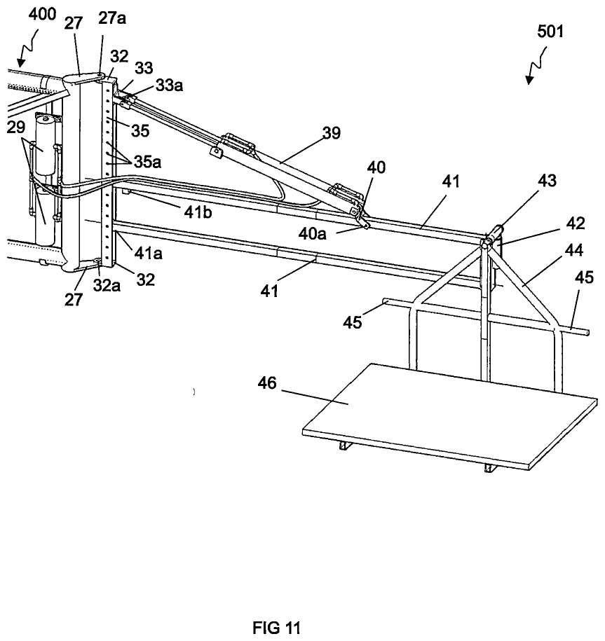

Apparatus 10 discloses parallel-arm lift arm assembly 500 with fork adapter picking device as shown in FIGS. 1, 10, and 14. All aspects of the assembly function and can be enhanced with all assemblies as described and referenced above in connection with apparatus 10, with the exception that in lieu of platform adapter picking device platform 46 of assembly 501, and in its place are two fork adapter picking device forks 47, designed to facilitate lifting of objects that require a fork-style adapter, such as pallets or trays.

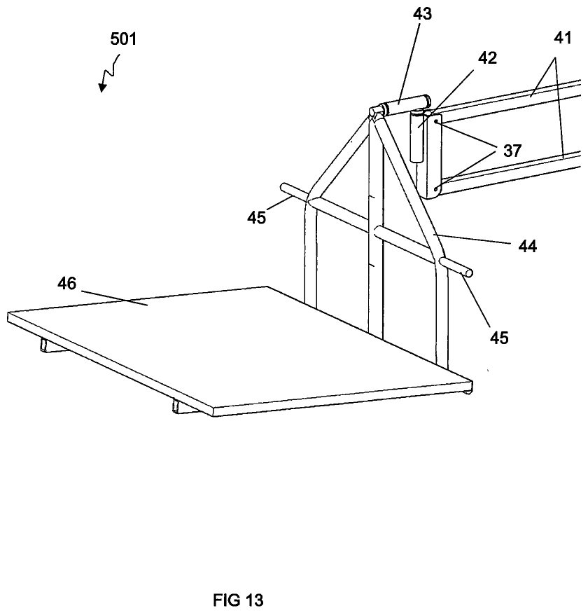

Apparatus 12 discloses parallel-arm lift arm assembly 502 with fork adapter picking device as shown in FIGS. 3 and 12. All aspects of the system function and can be enhanced with all systems as described and referenced above in connection with apparatus 10, with the exception that in lieu of assembly 501, assembly 502 is added to incorporate seated functionality, to transport humans. Thus, upper and lower seated lift assembly pivot tab 50 are fixedly attached at the top and bottom of seat lift vertical support beam/actuator 51 so as to be aligned with upper and lower extension hinge joint tab long 27 of the adjacent member of assembly 400 to facilitate connection via bolt or pin of seated lift pivot tab hole 50a to extension hinge joint tab long hole 27a, facilitating rotation about a substantially vertical axis of assembly 502. Vertical motion is achieved by a simple actuator mechanism which may consist of a number of popular drive mechanisms including, but not limited to, hydraulic, screw drive, pneumatic, rack and pinion, and other popular drive methods. Activation of seat lift vertical support beam/actuator 51 causes an up down movement of the assembly including seat lift seat horizontal support and pivot tray 52 and seat lift seat 56. Additional rotational flexibility in the positioning of the seat about a substantially vertical axis is provided by a combination of seat lift swivel flange assembly 53, seat lift locking pin 54, and seat lift locking pin handle 55.

FIG. 14 discloses system securement hook 58, whose purpose is to secure assembly 400 when stowed. It functions by engaging with either upper or lower parallel-arm lift arm assembly parallel arm 41 of assembly 500 or 501.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. An apparatus for lifting and transporting objects, the apparatus comprising:
a vertical support beam, the vertical support beam comprising at least one first attachment means for removably rotatably attaching an object for accepting lifted objects, the vertical support beam comprising at least one second attachment means for removably rotatably attaching a lifting apparatus for lifting objects;
a plurality outriggers pivotably attached to a lower end of the vertical support beam, each outrigger comprising an arm extending away from the vertical support beam in a substantially horizontal position in a deployed state and pivoting to a substantially vertical position in a stowed state, each outrigger arm having a mounting means substantially at an end thereof for supporting the vertical support beam in a substantially vertical orientation while in the deployed state.

2. The apparatus of claim 1, wherein the mounting means comprises a caster assembly.

3. The apparatus of claim 1, wherein the mounting means comprises a pad assembly.
